(19) United States
(12) Patent Application Publication
(10) Pub. No.: US 2025/0274956 A1
(43) Pub. Date: Aug. 28, 2025

(54) SIDELINK PHYSICAL LAYER STRUCTURE IN NR UNLICENSED

(71) Applicant: Apple Inc., Cupertino, CA (US)

(72) Inventors: Huaning Niu, San Jose, CA (US); Chunxuan Ye, San Diego, CA (US); Dawei Zhang, Saratoga, CA (US); Haitong Sun, Cupertino, CA (US); Hong He, San Jose, CA (US); Oghenekome Oteri, San Diego, CA (US); Sigen Ye, Whitehouse Station, NJ (US); Wei Zeng, Saratoga, CA (US); Weidong Yang, San Diego, CA (US); Yushu Zhang, Beijing (CN)

(21) Appl. No.: 18/858,170

(22) PCT Filed: Apr. 20, 2023
(86) PCT No.: PCT/US2023/019275

§ 371 Date: Oct. 18, 2024

Related U.S. Application Data
(60) Provisional application No. 63/333,332, filed on Apr. 21, 2022.

(51) Int. Cl. H04W 72/25; H04W 72/02; H04W 72/0446; H04W 72/0453; H04W 74/0808

(52) U.S. Cl. CPC H04W 72/25; H04W 72/02; H04W 72/0446; H04W 72/0453; H04W 74/0808

(57) ABSTRACT

Disclosed are methods, systems, and computer-readable medium to perform operations including: generating a communication for transmission on a sidelink channel operating in an unlicensed bandwidth; determining a configuration of a resource pool of the sidelink channel, where the configuration is based on one of a frame based equipment (FBE) or a load based equipment (LBE) mechanism; determining, from the resource pool, one or more resources on which to transmit the communication; and transmitting the communication on the sidelink channel using the one or more resources.

### CROSS-REFERENCE TO RELATED APPLICATIONS

The present application claims priority to U.S. Prov. App. No. 63/333,332, filed on Apr. 21, 2022, entitled “SIDELINK PHYSICAL LAYER STRUCTURE IN NR UNLICENSED,” which is incorporated herein by reference in its entirety.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

More recently, wireless communication networks have expanded network coverage by using user equipment (UEs) as relays. In particular, the relay UEs establish direct connections with other UEs to extend the network coverage to those UEs. The connection that a relay UE establishes with other UEs is referred to as a sidelink communication. Among other examples, the sidelink connection can be either a UE-to-network relay, where the relay UE connects a remote UE to the network, or a UE-to-UE relay, where the relay UE connects a first remote UE to a second remote UE.

### SUMMARY

This disclosure describes methods and systems that provide a sidelink design that meets the guidelines for sidelink unlicensed. In a one embodiment, a UE is configured to operate according to a frame based equipment (FBE) design. In this embodiment, the resource pool configuration is based on FBE and the physical structure meets FBE requirements. In another embodiment, a UE is configured to operate according to a load based equipment (LBE) design. In this embodiment, the resource pool configuration is based on LBE and the physical structure meets LBE requirements.

In accordance with one aspect of the present disclosure, a method to be performed by a user equipment (UE), involves: generating a communication for transmission on a sidelink channel operating in an unlicensed bandwidth; determining a configuration of a resource pool of the sidelink channel, where the configuration is based on one of a frame based equipment (FBE) or a load based equipment (LBE) mechanism; determining, from the resource pool, one or more resources on which to transmit the communication; and transmitting the communication on the sidelink channel using the one or more resources.

Other versions include corresponding systems, apparatus, and computer programs to perform the actions of methods defined by instructions encoded on computer readable storage devices. These and other versions may optionally include one or more of the following features.

In some implementations, where determining the configuration of a resource pool of the sidelink channel includes determining at least one of a frequency domain configuration or a time domain configuration.

In some implementations, where the configuration of the resource pool is based on the FBE mechanism, and where determining the frequency domain configuration includes: determining a number of frequency interlaces assigned to sidelink communications for the UE; determining, based on a subcarrier spacing of the sidelink channel, a number of physical resource blocks per interlace; and determining a physical resource block spacing in the sidelink channel.

In some implementations, where the configuration of the resource pool is based on the FBE mechanism, and where determining the time domain configuration includes: determining, based on at least one of a configured granularity of time domain resources or a subcarrier spacing of the sidelink channel, a number of slots in the time domain; and determining, based on a bitmap, one or more slots assigned to sidelink communications for the UE.

In some implementations, where the configuration of the resource pool is based on the FBE mechanism, and the method further including determining a physical layer structure for the one or more resources.

In some implementations, where the communication is a Physical Sidelink Control Channel (PSCCH) communication, and where transmitting the communication on the sidelink channel using the one or more resources includes: determining an interlace design for the PSCCH communication in the physical layer structure; and transmitting the PSCCH communication based on the interlace design.

In some implementations, where a first symbol of the physical layer structure is dedicated to automatic gain control (AGC).

In some implementations, where determining a physical layer structure for the one or more resources includes: calculating a minimum gap in the physical layer structure.

In some implementations, where the configuration of the resource pool is based on the LBE mechanism, and where determining the frequency domain configuration includes: determining whether a full bandwidth or a partial bandwidth of the sidelink channel is dedicated to the UE for sidelink communications.

In some implementations, where determining whether a full bandwidth or a partial bandwidth of the sidelink channel is dedicated to the UE for sidelink communications includes: determining that the partial bandwidth is dedicated to the UE for sidelink communications; and in response, determining to start transmission only at slot boundary after one additional one shot listen-before-talk (LBT).

In some implementations, where determining whether a full bandwidth or a partial bandwidth of the sidelink channel is dedicated to the UE for sidelink communications includes determining that the full bandwidth is dedicated to the UE for sidelink communications; and in response, determining to start transmission before a slot boundary.

In some implementations, where the configuration of the resource pool is based on the LBE mechanism, and where determining the time domain configuration includes: determining whether a full bandwidth or a partial bandwidth of the sidelink channel is dedicated to the UE for sidelink communications.

In some implementations, where determining whether a full bandwidth or a partial bandwidth of the sidelink channel is dedicated to the UE for sidelink communications includes: determining that the partial bandwidth is dedicated to the UE for sidelink communications; and in response, determining that a bitmap is used to configure starting points of the one or more resources on which to transmit the communication.

In some implementations, where determining whether a full bandwidth or a partial bandwidth of the sidelink channel is dedicated to the UE for sidelink communications includes determining that the full bandwidth is dedicated to the UE for sidelink communications; and in response, determining that transmitting the communication on the sidelink channel can start at any time.

In some implementations, where the configuration of the resource pool is based on the FBE mechanism, and the method further including determining a physical layer structure for the one or more resources.

In some implementations, where the communication is a Physical Sidelink Control Channel (PSCCH) communication, and where transmitting the communication on the sidelink channel using the one or more resources includes: determining an interlace design for the PSCCH communication in the physical layer structure; and transmitting the PSCCH communication based on the interlace design.

The details of one or more embodiments of these systems and methods are set forth in the accompanying drawings and description below. Other features, objects, and advantages of these systems and methods will be apparent from the description, drawings, and claims.

### BRIEF DESCRIPTION OF THE FIGURES

FIG. 1 illustrates an example communication system, according to some implementations.

FIG. 2 illustrates example frequency domain resource pool configurations for different subcarrier spacings, according to some implementations.

FIG. 3 illustrates example configurations of a time domain resource pool for FBE, according to some implementations.

FIGS. 4A-4C illustrate example physical layer structures for FBE, according to some implementations.

FIGS. 5A-5B illustrate example physical layer structures for LBE, according to some implementations.

FIG. 6 illustrates a flowchart of an example method, in accordance with some implementations.

FIG. 7 illustrates an example user equipment (UE), in accordance with some implementations.

FIG. 8 illustrates an example access node, in accordance with some implementations.

### DETAILED DESCRIPTION

Release 16 and Release 17 of the Third Generation Partnership Project (3GPP) standards describe a New Radio (NR) sidelink interface (also referred to as NR sidelink). The standards specify that the resource pool configurations only use a Cyclic Prefix-Orthogonal Frequency Division Multiplexing (CP-OFDM) waveform with a single carrier. The standards also specify that sidelink bandwidth parts use only one bandwidth part (BWP) for transmission (Tx) and reception (Rx). The sidelink BWP can include one or more resource pools. In the frequency domain, the standards specify that a sidelink resource pool uses a continuous allocation of Physical Resource Blocks (PRBs), and has a sub-channel granularity. Thus, each resource pool in a sidelink BWP can include one or more sub-channels. In the time domain, the standards specify that the sidelink resource pool has a slot granularity, and can include non-contiguous time resources.

The standards also describe a slot structure for slots that include a Physical Sidelink Shared Channel (PSSCH) and a Physical Sidelink Control Channel (PSCCH). The standards specify that PSSCH/PSCCH have a slot granularity. Further, the slot structure for PSCCH and PSCCH includes a first symbol for automatic gain control (AGC) training. This first symbol can, for example, include a copy of the second symbol. In the time domain, PSCCH start from the second symbol and last for 1 or 2 additional symbols (i.e., 2 or 3 symbol length). In the frequency domain, PSCCH is assigned to contiguous PRBs. This slot structure also includes a gap symbol, which can be a single symbol that is used for Tx/Rx switching.

More recently, a sidelink interface is being developed for operation in the unlicensed spectrum. The industry has agreed upon guidelines for developing sidelink unlicensed. These guidelines include regulatory guidelines that user devices are expected to meet. One set of guidelines is related to transmission bandwidth and specifies that the transmission bandwidth should meet 80% of the Occupied Channel Bandwidth (OCB). This rule is referred to as the “80% OCB requirement.” More particularly, the guidelines specify that the OCB should be between 80% and 100% of the Nominal Channel Bandwidth (NCB). The Nominal Channel Bandwidth can be, for example, 20 Megahertz (MHz). The guidelines also specify an exception to the 80% OCB requirement. The exception, called the 2 MHz temporary exception, allows transmission under 2 MHz in scenarios where the 80% OCB requirement is not met.

However, the previously described features of NR sidelink do not meet the OCB requirement. For example, the existing sidelink design uses contiguous PRBs in the frequency domain, which does not meet the OCB requirement. The existing sidelink design also does not describe channel access procedures to use for communications in the unlicensed spectrum. Further, the slot based time domain allocation of existing sidelink design does not fit well with channel access procedures.

This disclosure describes methods and systems that provide a sidelink design that meets the guidelines for sidelink unlicensed. In one embodiment, a UE is configured to operate according to a frame based equipment (FBE) design. In this embodiment, the resource pool configuration is based on FBE and the physical structure meets FBE requirements. In another embodiment, a UE is configured to operate according to a load based equipment (LBE) design. In this embodiment, the resource pool configuration is based on LBE and the physical structure meets LBE requirements.

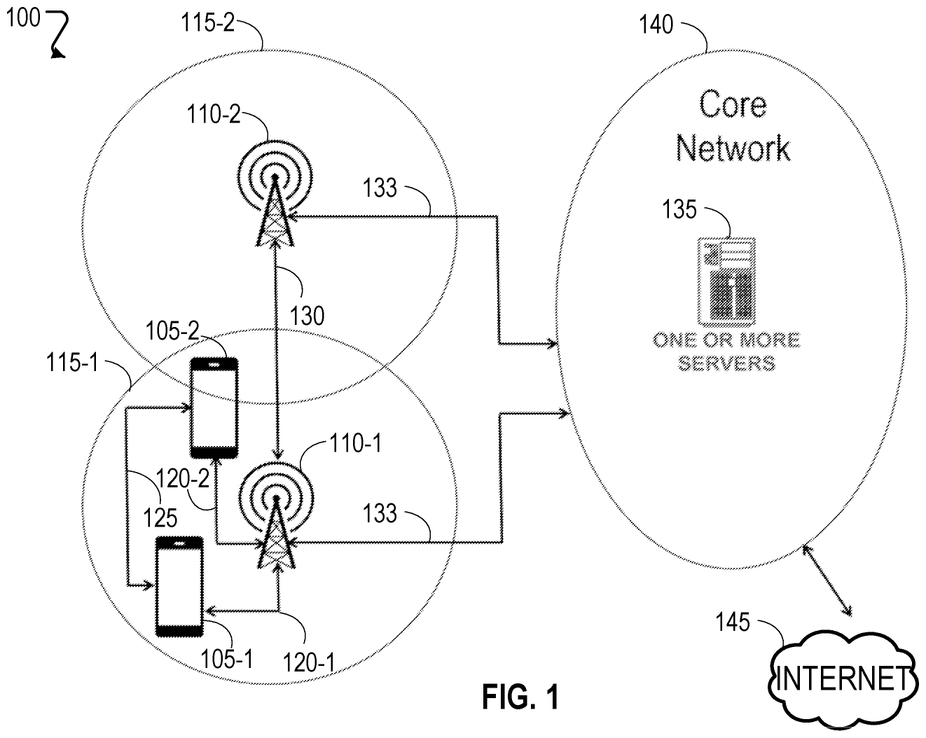

FIG. 1 illustrates an example communication system 100, according to some implementations. It is noted that the system of FIG. 1 is merely one example of a possible system, and that features of this disclosure may be implemented in other wireless communication systems.

The following description is provided for an example communication system 100 that operates in conjunction with fifth generation (5G) networks as provided by 3rd Generation Partnership Project (3GPP) technical specifications (TS). However, the example implementations are not limited in this regard and the described implementations may apply to other networks that may benefit from the principles described herein, such as 3GPP Long Term Evolution (LTE) networks, Wi-Fi networks, and the like. Furthermore, other types of communication standards are possible, including future 3GPP systems (e.g., Sixth Generation (6G) systems), IEEE protocols, or the like. While aspects may be described herein using terminology commonly associated with 5G NR, aspects of the present disclosure can be applied to other systems, such as 3G, 4G, and/or systems subsequent to 5G (e.g., 6G).

As shown, the communication system 100 includes a number of user devices. As used herein, the term “user devices” may refer generally to devices that are associated with mobile actors or traffic participants in the communication system 100, e.g., mobile (able-to-move) communication devices such as vehicles and pedestrian user equipment (PUE) devices. More specifically, the communication system 100 includes two UEs 105 (UE 105-1 and UE 105-2 are collectively referred to as “UE 105” or “UEs 105”), two base stations 110 (base station 110-1 and base station 110-2 are collectively referred to as “base station 110” or “base stations 110”), two cells 115 (cell 115-1 and cell 115-2 are collectively referred to as “cell 115” or “cells 115”), and one or more servers 135 in a core network (CN) 140 that is connected to the Internet 145.

In some implementations, the UEs 105 can directly communicate with base stations 110 via links 120 (link 120-1 and link 120-2 are collectively referred to as “link 120” or “links 120”), which utilize a direct interface with the base stations referred to as a “Uu interface.” Each of the links 120 can represent one or more channels. The links 120 are illustrated as an air interface to enable communicative coupling, and can be consistent with cellular communication protocols, such as a 3GPP LTE protocol, an Advanced long term evolution (LTE-A) protocol, a LTE-based access to unlicensed spectrum (LTE-U), a 5G NR protocol, an NR-based access to unlicensed spectrum (NR-U) protocol, and/or any of the other communications protocols discussed herein.

As shown, certain user devices may be able to conduct communications with one another directly, i.e., without an intermediary infrastructure device such as base station 110-1. As shown, UE 105-1 may conduct communications (e.g., V2X-related communications) directly with UE 105-2. Similarly, the UE 105-2 may conduct communications directly with UE 105-1. Such peer-to-peer communications may utilize a “sidelink” interface such as a PC5 interface. In certain implementations, the PC5 interface supports direct cellular communication between user devices (e.g., between UEs 105), while the Uu interface supports cellular communications with infrastructure devices such as base stations. For example, the UEs 105 may use the PC5 interface for a radio resource control (RRC) signaling exchange between the UEs. The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations.

In some implementations, the UEs 105 may be configured with parameters for communicating via the Uu interface and/or the sidelink interface. In some examples, the UEs 105 may be “pre-configured” with some parameters. In these examples, the parameters may be hardwired into the UEs 105 or coded into spec. Additionally and/or alternatively, the UEs 105 may be “configured” with the parameters from the one or more of the base stations 110. In this disclosure, “(pre)configured” means that “pre-configuration” and “configuration” are both possible.

To transmit/receive data to/from one or more base stations 110 or UEs 105, the UEs 105 may include a transmitter/receiver (or alternatively, a transceiver), memory, one or more processors, and/or other like components that enable the UEs 105 to operate in accordance with one or more wireless communications protocols and/or one or more cellular communications protocols. The UEs 105 may have multiple antenna elements that enable the UEs 105 to maintain multiple links 120 and/or sidelinks 125 to transmit/receive data to/from multiple base stations 110 and/or multiple UEs 105. For example, as shown in FIG. 1, UE 105-1 may connect with base station 110-1 via link 120-1 and simultaneously connect with UE 105-2 via sidelink 125.

In some implementations, one or more sidelink radio bearers may be established on the sidelink 125. The sidelink radio bearers can include signaling radio bearers (SL-SRB) and/or data radio bearers (SL-DRB).

The PC5 interface may alternatively be referred to as a sidelink interface and may include one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), Physical Sidelink Feedback Channel (PSFCH), and/or any other like communications channels. The PSFCH carries feedback related to the successful or failed reception of a sidelink transmission. The PSSCH can be scheduled by sidelink control information (SCI) carried in the sidelink PSCCH. The SCI can be transmitted in two stages. The 1st-stage SCI is carried on the PSCCH while the 2nd-stage SCI is carried on the corresponding PSSCH. For example, 2-stage SCI can be used by applying the 1st SCI for the purpose of sensing and broadcast communication, and the 2nd SCI carrying the remaining information for data scheduling of unicast/groupcast data transmission. In some examples, the sidelink interface can operate on an unlicensed spectrum (e.g., in the unlicensed 5 Gigahertz (GHz) and 6 GHz bands) or a (licensed) shared spectrum.

In some implementations, UEs 105 may be physical hardware devices capable of running one or more applications, capable of accessing network services via one or more radio links 120 with a corresponding base station 110, and capable of communicating with one another via sidelink 125. Link 120 may allow the UEs 105 to transmit and receive data from the base station 110 that provides the link 120. The sidelink 125 may allow the UEs 105 to transmit and receive data from one another. The sidelink 125 between the UEs 105 may include one or more channels for transmitting information from UE 105-1 to UE 105-2 and vice versa and/or between UEs 105 and UE-type RSUs (not shown in FIG. 1) and vice versa.

In some implementations, the base stations 110 are capable of communicating with one another over a backhaul connection 130 and may communicate with the one or more servers 135 within the CN 140 over another backhaul connection 133. The backhaul connections can be wired and/or wireless connections.

In some implementations, the sidelink 125 is established through an initial beam pairing procedure. In this procedure, the UEs 105 identify (e.g., using a beam selection procedure) one or more potential beam pairs that could be used for the sidelink 125. A beam pair includes a transmitter beam from a transmitter UE (e.g., UE 105-1) to a receiver UE (e.g., UE 105-2) and a receiver beam from the receiver UE to the transmitter UE. In some examples, the UEs 105 rank the one or more potential beam pairs. Then, the UEs 105 select one of the one or more potential beam pairs for the sidelink 125, perhaps based on the ranking.

As stated, the air interface between two or more UEs 105 or between a UE 105 and a UE-type RSU (not shown in FIG. 1) may be referred to as a PC5 interface. To transmit/receive data to/from one or more eNBs 110 or UEs 105, the UEs 105 may include a transmitter/receiver (or alternatively, a transceiver), memory, one or more processors, and/or other like components that enable the UEs 105 to operate in accordance with one or more wireless communications protocols and/or one or more cellular communication protocols. The UEs 105 may have multiple antenna elements that enable the UEs 105 to maintain multiple links 120 and/or sidelinks 125 to transmit/receive data to/from multiple base stations 110 and/or multiple UEs 105. For example, as shown in FIG. 1, UE 105 may connect with base station 110-1 via link 120 and simultaneously connect with UE 105-2 via sidelink 125.

In some implementations, the UEs 105 are configured to use a resource pool for sidelink communications. A sidelink resource pool may be divided into multiple time slots, frequency channels, and frequency sub-channels. In some examples, the UEs 105 are synchronized and perform sidelink transmissions aligned with slot boundaries. A UE may be expected to select several slots and sub-channels for transmission of the transport block. In some aspects, a UE may use different sub-channels for transmission of the transport block across multiple slots within its own resource selection window, which may be determined using packet delay budget information.

In some implementations, the communication system 100 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

In some implementations, when communicating via sidelink unlicensed, a UE, e.g., UEs 105, is configured to operate according to a frame based equipment (FBE) design described in Section 4.2.7.3.1 of ETSI EN 301 893. Among other things, this section specifies that Frame Based Equipment is equipment in which the transmit/receive structure has a periodic timing with a periodicity equal to a Fixed Frame Period. Further, this section specifies that FBE implements a Listen Before Talk (LBT) based Channel Access Mechanism to detect the presence of other transmissions on an Operating Channel. The Fixed Frame Periods supported by the FBE is within a range of 1 millisecond (ms) to 10 ms, and transmissions can start only at the beginning of a Fixed Frame period. Furthermore, this section specifies that Channel Occupancy Time is not more than 95% of the Fixed Frame Period, and is followed by an Idle Period until the start of the next Fixed Frame Period such that the Idle Period (or gap) is at least 5% of the Channel Occupancy Time, with a minimum of 100 microseconds (us).

In some implementations, to operate according to FBE design, the UE is configured with a frequency domain resource pool configuration specific to FBE. In some examples, the frequency domain resource pool configuration uses an interlaced waveform. In some examples, a bandwidth part (BWP) that is used in the frequency domain resource pool configuration has a minimum sensing bandwidth (BW), e.g., 20 MHz. A sensing BW of at least 20 MHz allows the UE to perform channel access procedures for FBE. In some examples, a plurality of BWPs or carriers are configured per UE. As such, the UE can transmit on a wider bandwidth (e.g., greater than 20 MHz). In these examples, the plurality of BWPs can be adjacent or non-adjacent, and the channel access is performed per sensing BW.

In some implementations, the granularity of frequency domain allocation within a BWP is one interlace, but other number of interlaces (e.g., two or more interlaces) are also possible. More specifically, the resource pool can be configured using a minimum of one interlace, up to all interlaces within a BWP (e.g., all PRBs within a BWP are used for a UE's resource pool). In some examples, for a channel with 15 KHz or 30 KHz subcarrier spacing (SCS), the number of PRBs per interlace, N, is 10 or 11. Further, for a channel with 15 KHz or 30 KHz SCS, the spacing between interlaces (PRB spacing), M, is 5 or 10. For a channel with 60 KHz SCS, the PRB spacing, M, can be equal to 2, 3, or 2.5 (e.g., alternating between 2 and 3). Here, the number of PRBs per interlace, N, is derived from M.

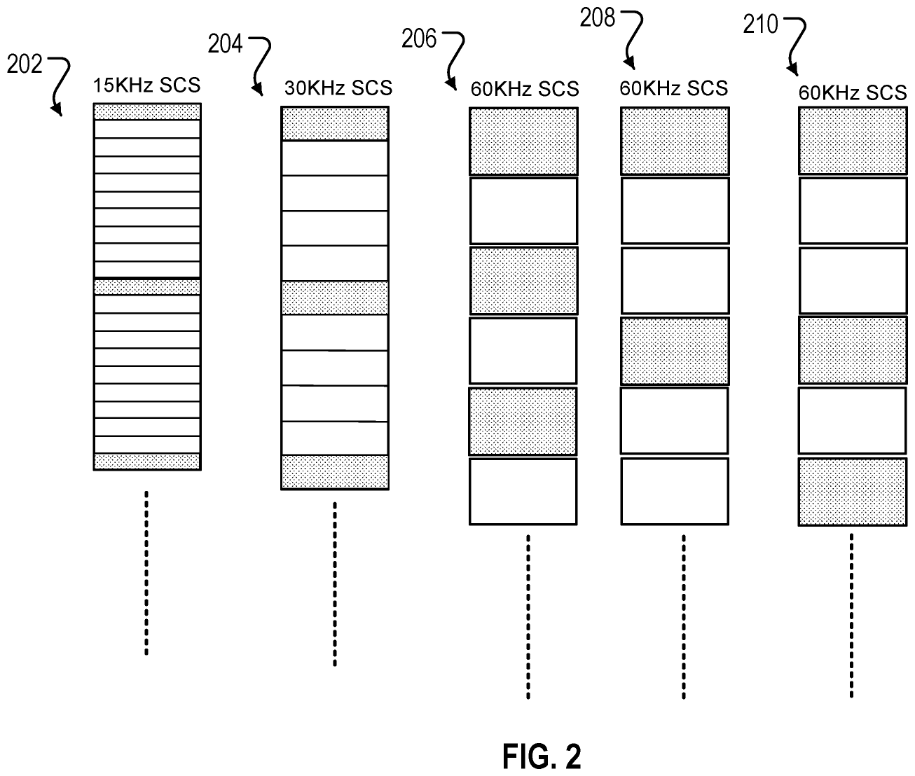

FIG. 2 illustrates example frequency domain resource pool configurations for different subcarrier spacings, according to some implementations. More specifically, FIG. 2 illustrates a configuration 202 for a channel with 15 KHz SCS, a configuration 204 for a channel with 30 KHz SCS, a first configuration 206 for a channel with 60 KHz SCS, a second configuration 208 for a channel with 60 KHz SCS, and a third configuration 210 for a channel with 60 KHz SCS.

Starting with the configuration 202, the channel has a SCS of 15 KHz SCS and a plurality of PRB groups, where each PRB group can be occupied by an interlace. The configuration 202 includes one repeating interlace across the channel band. The PRB spacing, M, is equal to 10. Further, the number of PRBs per interlace (or per PRB group), N, can be 10 or 11. In the configuration 204, the channel has a SCS of 30 KHz SCS and a plurality of PRB groups. The configuration 204 includes one repeating interlace across the channel band. The PRB spacing, M, is equal to 5. Further, the number of PRBs per interlace (or per PRB group), N, can be 10 or 11. In the configurations 206, 208, 210, the channel has an SCS of 60 KHz SCS and a plurality of PRB groups. The configurations 206, 208, 210 include one repeating interlace across the channel band. However, the configurations 206, 208, 210 have different PRB spacing, M. The configuration 206 has a PRB spacing of 2, the configuration 208 has a PRB spacing of 3, and the configuration 210 has a PRB spacing of 10.

In some implementations, the UE is configured with a time domain resource pool configuration for FBE. In an example, the granularity of the time domain resource pool is 1 ms. The number of slots is determined based on the granularity and the SCS. For a granularity of 1 ms, the number of slots is 1 for 15 KHz SCS, 2 for 30 KHz SCS, and 4 for 60 KHz SCS. In another example, the network can configure granularity/periodicity to be any value between 1-10 ms. In these examples, the number of slots scales based on the SCS.

In some implementations, the time resource allocation for each slot is indicated by a bitmap. More specifically, the bitmap may indicate the resources that are available for SL-U transmission. In some examples, a value of “1” in the bitmap indicates that the corresponding period/granularity (e.g., 1-10 ms) is available for a sidelink transmission. The bitmap reference is slot #0 of the radio frame corresponding to SFN 0 of the serving cell if the serving cell timing reference in use starts from SFN0. In some examples, the periodicity at which the time resource pool occurs is 10240 ms. In some examples, all of the resources within the slot are dedicated for SL-U transmission.

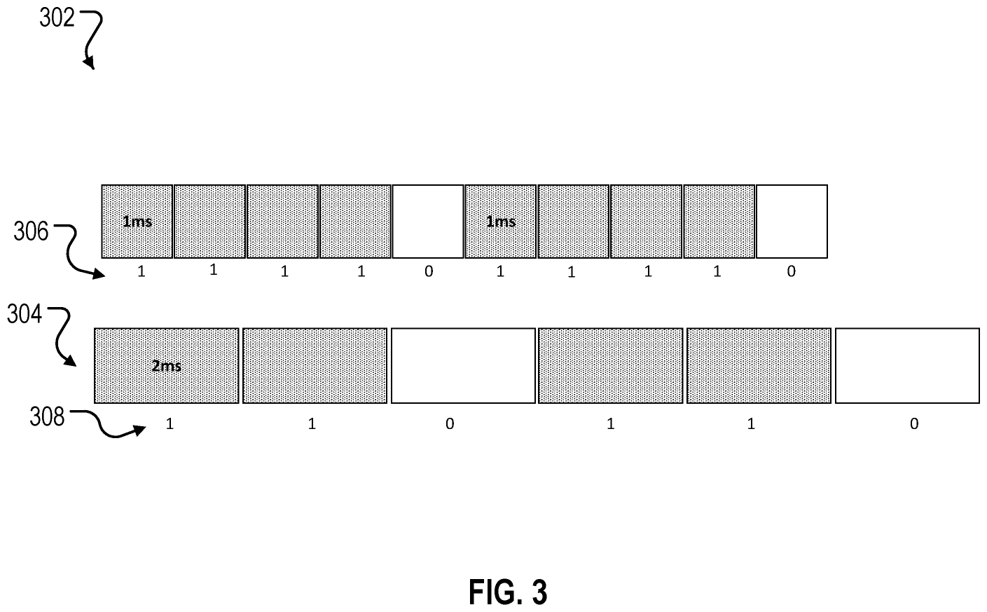

FIG. 3 illustrates example configurations 302, 304 of a time domain resource pool for FBE, according to some implementations. More specifically, FIG. 3 illustrates the configurations 302, 304 for one radio frame, which in this example, has a length of 10 ms. Starting with the configuration 302, the periodicity in the configuration 302 is 1 ms. Thus, the configuration 302 includes 10 subframes within the radio frame of 10 ms. The number of slots within each subframe depends on the SCS. As also shown in FIG. 3, a bitmap 306 can be used to identify the time resources that can be used for SL-U transmissions. For example, a value of “1” indicates that the time resource can be used for SL-U transmissions and a value of “0” indicates that the time resource cannot be used for SL-U transmissions. Turning to the configuration 304, the configuration has a periodicity of 2 ms. Thus, the configuration 304 includes 5 subframes within the radio frame of 10 ms. The number of slots within each subframe depends on the SCS. As also shown in FIG. 3, a bitmap 308 can be used to identify the time resources that can be used for SL-U transmissions.

In some implementations, when operating in the FBE mode, the UE is configured to use a physical layer structure that includes interleaved resources in the frequency domain. In particular, the interleaved resources can include a plurality resource blocks that are interleaved across the channel band. And in the time domain, the physical layer structure includes a plurality of slots in a radio frame. In some examples, some of the time domain resources are dedicated to an Idle Period (or gap). As stated previously, the minimum gap for FBE is calculated as max (5% of periodicity, 100 us). In some examples, the UE is configured to use a LBT category for the channel access procedure. In one example, the UE uses a CAT2 LBT for channel access before transmission. CAT2 specifies LBT without random back-off, with a deterministic a Clear Channel Assessment (CCA) period (e.g., one shot 25 us LBT).

In some examples, the UE can multiplex PSCCH and PSSCH in the configured physical layer structure. For instance, PSCCH can be time division multiplexed and/or frequency division multiplexed with PSSCH. In some examples, the UE is configured to select one of one or more options for PSCCH interlaces. In a first option, Option 1, the PSCCH occupies one or more interlaces (e.g., 10 or 11 resource blocks, 20 or 22 resource blocks, etc.) in a sub-channel. In a second option, Option 2, PSCCH occupies a partial interlace, e.g., 5 resource blocks, in a sub-channel.

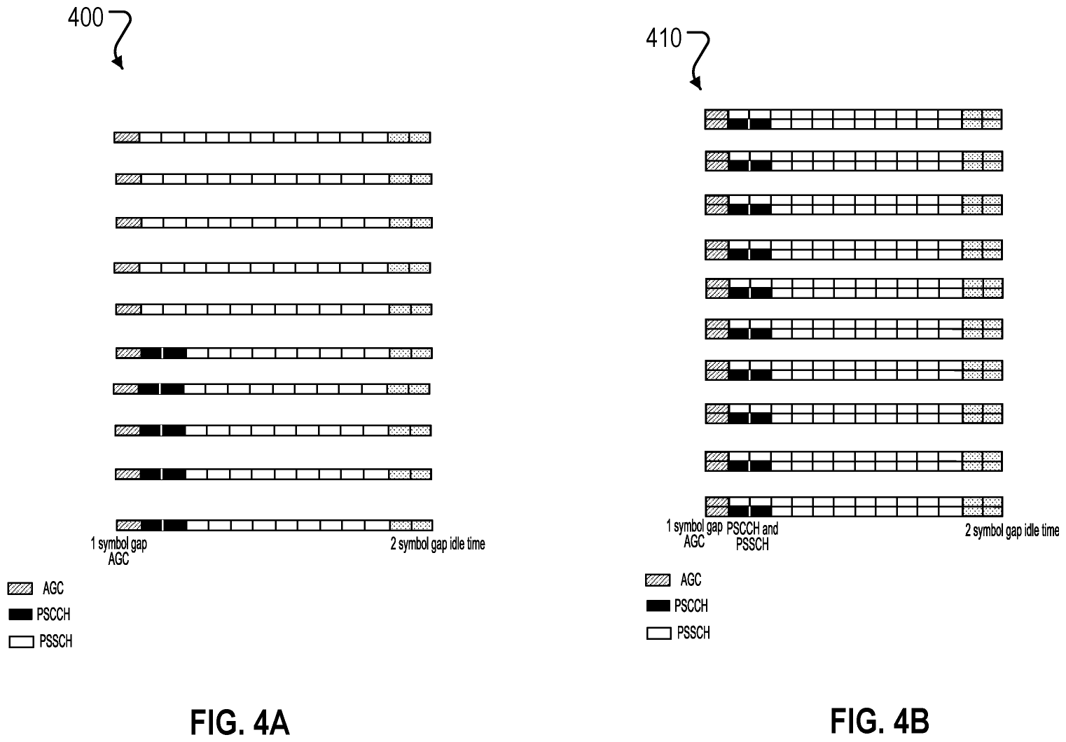

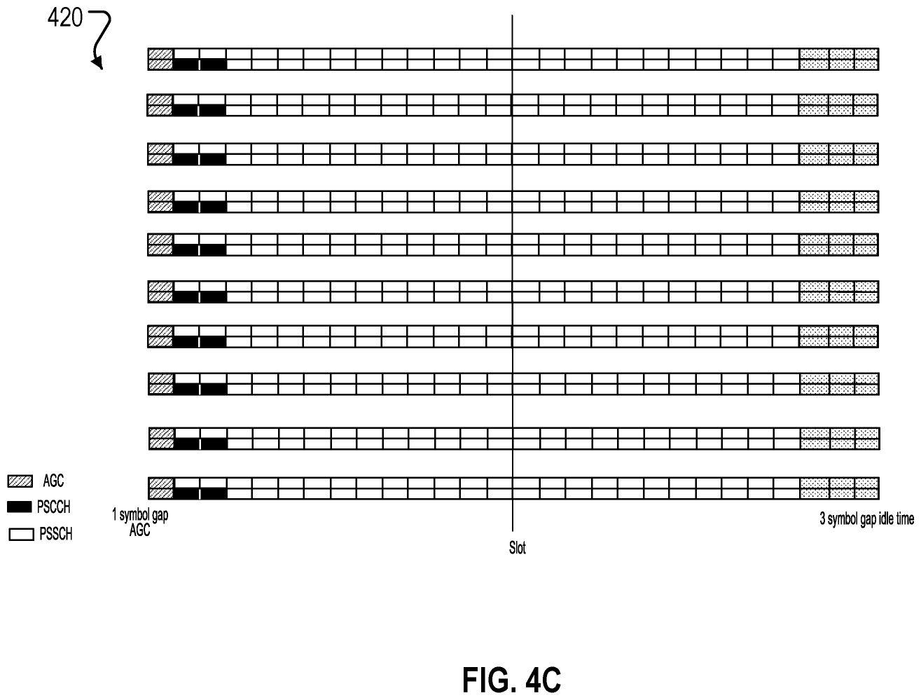

FIGS. 4A-4C illustrate example physical layer structures for FBE, according to some implementations. In these figures, the time domain resources have a periodicity of 1 ms. Furthermore, in these figures, the channel band is 20 MHz, but other frequencies are also possible. As described previously, a 20 MHz BWP has total of 10 interlaces with 15 KHz SCS, and a total of 5 interlaces for 30 KHz SCS.

FIG. 4A illustrates a structure 400 that includes 10 PRBs across the channel band (e.g., 20 MHz band) that are dedicated for SL-U transmissions, where the SCS is 15 KHz. Here, the SL-U transmission is using one interlace of the 10 interlaces of the 20 MHz BWP. In this example, PSCCH is multiplexed using a half interlace and two symbols. Thus, as shown in FIG. 4A, PSCCH is multiplexed across two symbols in 5 of the PRBs used for SL-U transmission. As also shown in FIG. 4A, PSSCH is also allocated one interlace.

FIG. 4B illustrates a structure 410 that includes 20 PRBs across the channel band that are dedicated for SL-U transmissions, where the SCS is 15 KHz. Here, the SL-U transmission is using two interlaces of the 10 interlaces of the 20 MHz BWP. In this example, PSCCH is multiplexed using one interlace in frequency and across two symbols in time. Thus, as shown in FIG. 4B, PSCCH is multiplexed across two symbols in 10 of the PRBs used for SL-U transmission. In some examples, the PSCCH/PSSCH transmission in SL-U is transmitted in one interlace per sub-channel. In other examples, the PSCCH/PSSCH transmission in SL-U is transmitted in more than one interlace per sub-channel (e.g., two interlaces). As also shown in FIG. 4B, PSSCH is transmitted in two interlaces of the sub-channel, whereas, as stated, the PSCCH is transmitted in one interlace.

FIG. 4C illustrates a structure 420 that includes 20 PRBs across the channel band that are dedicated for SL-U transmissions, where the SCS is 30 KHz. Because the SCS is 30 KHz, there are two slots in the subframe of 10 ms, where each slot includes 14 symbols. In this example, PSCCH is multiplexed using one interlace in frequency and across two symbols in time. Thus, as shown in FIG. 4C, PSCCH is multiplexed across two symbols in 10 of the PRBs used for SL-U transmission. In some examples, the PSCCH/PSSCH transmission in SL-U is transmitted in one interlace per sub-channel. In other examples, the PSCCH/PSSCH transmission in SL-U is transmitted in more than one interlace per sub-channel (e.g., two interlaces). As also shown in FIG. 4C, PSSCH is transmitted in two interlaces of a sub-channel, whereas, as stated, the PSCCH is transmitted in one interlace. In some examples where PSCCH takes one interlace/sub-channel when PSSCH takes two interlaces/sub-channel, the PSCCH takes a lower sub-channel/interlace.

In some implementations, when communicating via sidelink unlicensed, a UE, e.g., UEs 105, is configured to operate according to a load-based equipment (LBE) design. LBE devices may utilize a transmit/receive structure that is not fixed in time but is instead demand-driven. An LBE device may perform CCA at need. If the channel is not available, the LBE device may perform an extended CCA, having an extended sensing duration.

To operate according to LBE design, the UE is configured with a frequency domain resource pool configuration specific to LBE. In one example, the frequency domain pool is located within a partial bandwidth. In another example, the frequency domain pool is located within the full bandwidth (e.g., 20 MHz). Whether the partial bandwidth or the full bandwidth is used affects the CCA approach that is used for sensing. For the partial bandwidth, Type 1 LBT is used for CCA, and transmission only starts at slot boundary after one additional one shot LBT. For the full bandwidth, Type 1 LBT is also used for CCA. However, the transmission starts immediately after type 1 LBT is successful, which can be before slot boundary. CP extension will be transmitted before the slot boundary starts. The transmitted signal can be further extension of the AGC symbol. Doing so allows the UE to reserve the channel for its transmission opportunity.

The reason that a different CCA approach is used for partial bandwidth as opposed to the full bandwidth is that, in the partial bandwidth, a UE is assigned one or more interlaces and shares the bandwidth with other UEs. To avoid collisions between the different UEs, transmission only starts at the slot boundary (after additional one shot LBT). For example, assuming that there are two UEs sharing the bandwidth (each occupying partial bandwidth), each UE performs its independent LBT. Once the LBT period is over, each UE holds and does not perform a channel access process. Rather, both UEs perform another one shot LBT (e.g., 16 us sensing), and if successful, both UEs start transmission together at the slot boundary. Therefore, one UE will not block transmission of the other UE.

In some implementations, the UE is configured with a time domain resource pool configuration specific to LBE. The characteristics of the time domain resource pool depends on whether the full or partial bandwidth is allocated for the UE. When the full bandwidth is used, the UE can start transmission at any time in any slot. Alternatively, a bitmap is used to configure potential starting points in time. Whether or not a bitmap is used is up to network configuration. When the partial bandwidth, a bitmap is used to configure potential starting points in time.

In some implementations, when operating in the LBE mode, the UE is configured to use a physical layer structure that includes interleaved resources in the frequency domain. In particular, the interleaved resources can include a plurality resource blocks that are interleaved across the channel band. And in the time domain, the physical layer structure includes a plurality of slots in a radio frame.

In some examples, the UE can multiplex PSCCH and PSSCH in the configured physical layer structure. For instance, PSCCH can be time division multiplexed and/or frequency division multiplexed with PSSCH. In some examples, the UE is configured to select one of one or more options for PSCCH interlaces. In a first option, Option 1, the PSCCH occupies one or more interlaces (e.g., 10 or 11 resource blocks, 20 or 22 resource blocks, etc.). In a second option, Option 2, PSCCH occupies partial interlaces, e.g., 5 resource blocks.

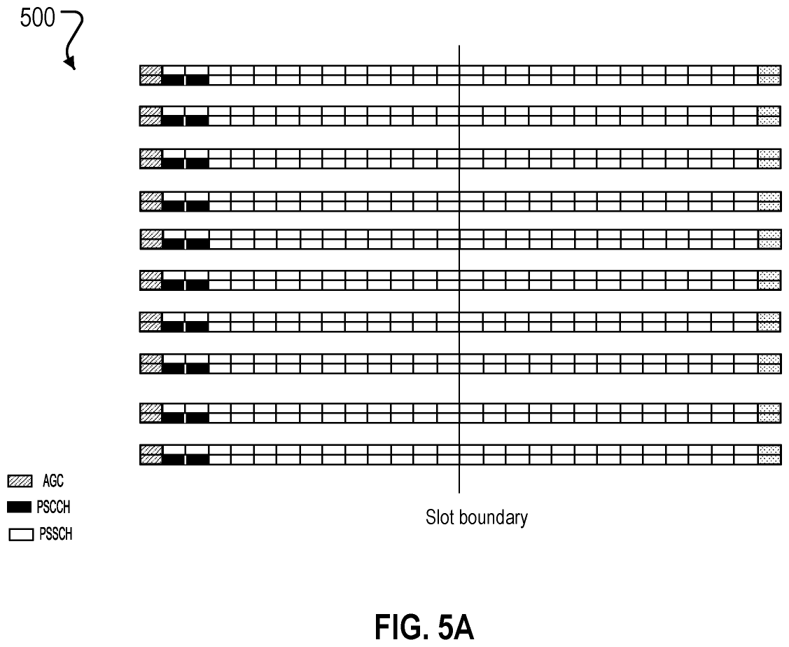

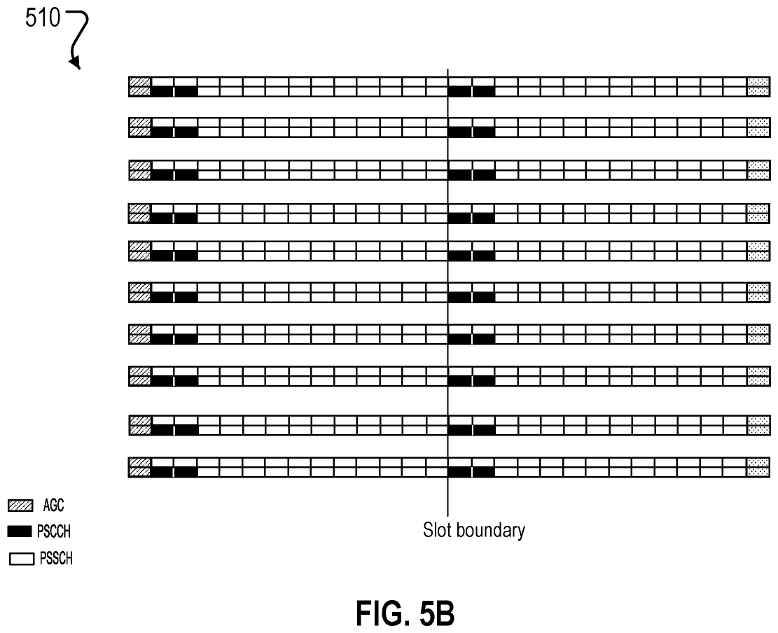

In some implementations, since each transmission can be multiple slots once CCA is successful, the channel design can be across multiple slots (e.g., 2 slots as shown in FIGS. 5A and 5B). In some implementations, a cross slot structure is used. In these implementations, an AGC symbol is included at the beginning slot of each burst. The AGC symbol is the repetition of the second symbol. As another alternative, the AGC symbol can be transmitted at the beginning of every X slot, e.g., X=2.

In some implementations, the UE is configured to select one of one or more options for PSCCH transmissions. In a first option, Option 1, the PSCCH is in the 1st slots in multi-slots transmission. In a second option, Option 2, a PSCCH duplicate is included in each slot. In a third option, Option 3, a PSCCH duplicate is included in the first N slots, e.g., N=2. For Options 1 and 3, the transport block size for the PSSCH may be determined based on the indicated Modulation and Coding Scheme (MCS) and resource elements for one PSSCH transmission occasion, e.g., the first PSSCH transmission occasion.

FIGS. 5A-5B illustrate example physical layer structures for LBE, according to some implementations. FIG. 5A illustrates a structure 500 that includes 20 PRBs across the channel band that are dedicated for SL-U transmissions. In this example, PSCCH is multiplexed using one interlace in frequency and across two symbols in time. Thus, as shown in FIG. 5A, PSCCH is multiplexed across two symbols in 10 of the PRBs used for SL-U transmission. FIG. 5B illustrates a structure 510 that includes 20 PRBs across the channel band that are dedicated for SL-U transmissions. In this example, PSCCH is multiplexed using one interlace in frequency and across two symbols in time. Further, PSCCH is multiplexed in each slot. In both structures 500, 510, there is only a gap of one symbol.

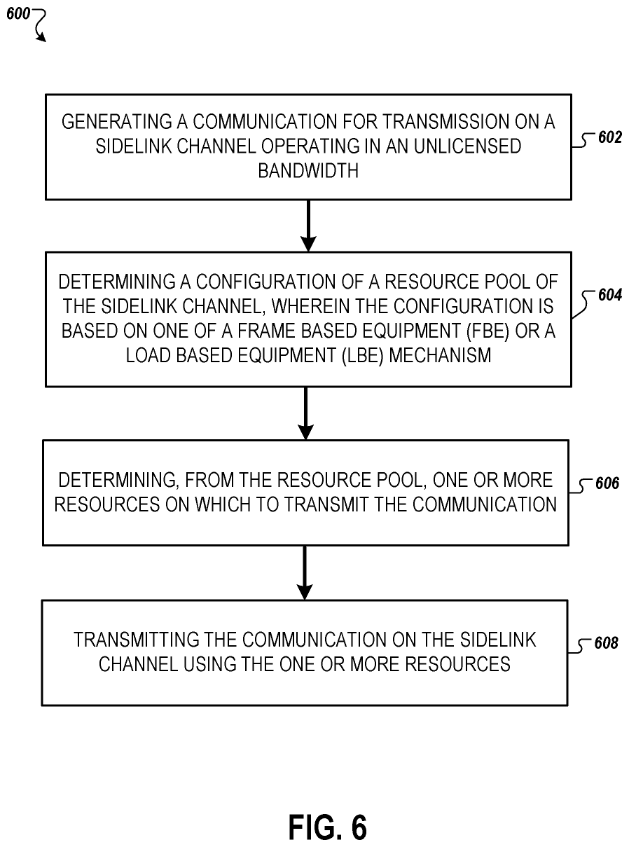

FIG. 6 illustrates a flowchart of an example method 600, in accordance with some implementations. For clarity of presentation, the description that follows generally describes method 700 in the context of the other figures in this description. For example, method 600 can be performed by the UEs 105 of FIG. 1. It will be understood that method 600 can be performed, for example, by any suitable system, environment, software, hardware, or a combination of systems, environments, software, and hardware, as appropriate. In some implementations, various steps of method 600 can be run in parallel, in combination, in loops, or in any order. In some implementations, the method 600 is performed by a UE.

At step 602, method 600 involves generating a communication for transmission on a sidelink channel operating in an unlicensed bandwidth.

At step 604, method 600 involves determining a configuration of a resource pool of the sidelink channel, where the configuration is based on one of a frame-based equipment (FBE) or a load based equipment (LBE) mechanism.

At step 606, method 600 involves determining, from the resource pool, one or more resources on which to transmit the communication.

At step 608, method 600 involves transmitting the communication on the sidelink channel using the one or more resources.

In some implementations, where determining the configuration of a resource pool of the sidelink channel includes determining at least one of a frequency domain configuration or a time domain configuration.

In some implementations, where the configuration of the resource pool is based on the FBE mechanism, and where determining the frequency domain configuration includes: determining a number of frequency interlaces assigned to sidelink communications for the UE; determining, based on a subcarrier spacing of the sidelink channel, a number of physical resource blocks per interlace; and determining a physical resource block spacing in the sidelink channel.

In some implementations, where the configuration of the resource pool is based on the FBE mechanism, and where determining the time domain configuration includes: determining, based on at least one of a configured granularity of time domain resources or a subcarrier spacing of the sidelink channel, a number of slots in the time domain; and determining, based on a bitmap, one or more slots assigned to sidelink communications for the UE.

In some implementations, where the configuration of the resource pool is based on the FBE mechanism, and the method further including determining a physical layer structure for the one or more resources.

In some implementations, where the communication is a Physical Sidelink Control Channel (PSCCH) communication, and where transmitting the communication on the sidelink channel using the one or more resources includes: determining an interlace design for the PSCCH communication in the physical layer structure; and transmitting the PSCCH communication based on the interlace design.

In some implementations, where a first symbol of the physical layer structure is dedicated to automatic gain control (AGC).

In some implementations, where determining a physical layer structure for the one or more resources includes: calculating a minimum gap in the physical layer structure.

In some implementations, where the configuration of the resource pool is based on the LBE mechanism, and where determining the frequency domain configuration includes determining whether a full bandwidth or a partial bandwidth of the sidelink channel is dedicated to the UE for sidelink communications.

In some implementations, where determining whether a full bandwidth or a partial bandwidth of the sidelink channel is dedicated to the UE for sidelink communications includes: determining that the partial bandwidth is dedicated to the UE for sidelink communications; and in response, determining to start transmission only at slot boundary after one additional one shot listen-before-talk (LBT).

In some implementations, where determining whether a full bandwidth or a partial bandwidth of the sidelink channel is dedicated to the UE for sidelink communications includes determining that the full bandwidth is dedicated to the UE for sidelink communications; and in response, determining to start transmission before a slot boundary.

In some implementations, where the configuration of the resource pool is based on the LBE mechanism, and where determining the time domain configuration includes determining whether a full bandwidth or a partial bandwidth of the sidelink channel is dedicated to the UE for sidelink communications.

In some implementations, where determining whether a full bandwidth or a partial bandwidth of the sidelink channel is dedicated to the UE for sidelink communications includes: determining that the partial bandwidth is dedicated to the UE for sidelink communications; and in response, determining that a bitmap is used to configure starting points of the one or more resources on which to transmit the communication.

In some implementations, where determining whether a full bandwidth or a partial bandwidth of the sidelink channel is dedicated to the UE for sidelink communications includes determining that the full bandwidth is dedicated to the UE for sidelink communications; and in response, determining that transmitting the communication on the sidelink channel can start at any time.

In some implementations, where the configuration of the resource pool is based on the FBE mechanism, and the method further including determining a physical layer structure for the one or more resources.

In some implementations, where the communication is a Physical Sidelink Control Channel (PSCCH) communication, and where transmitting the communication on the sidelink channel using the one or more resources includes: determining an interlace design for the PSCCH communication in the physical layer structure; and transmitting the PSCCH communication based on the interlace design.

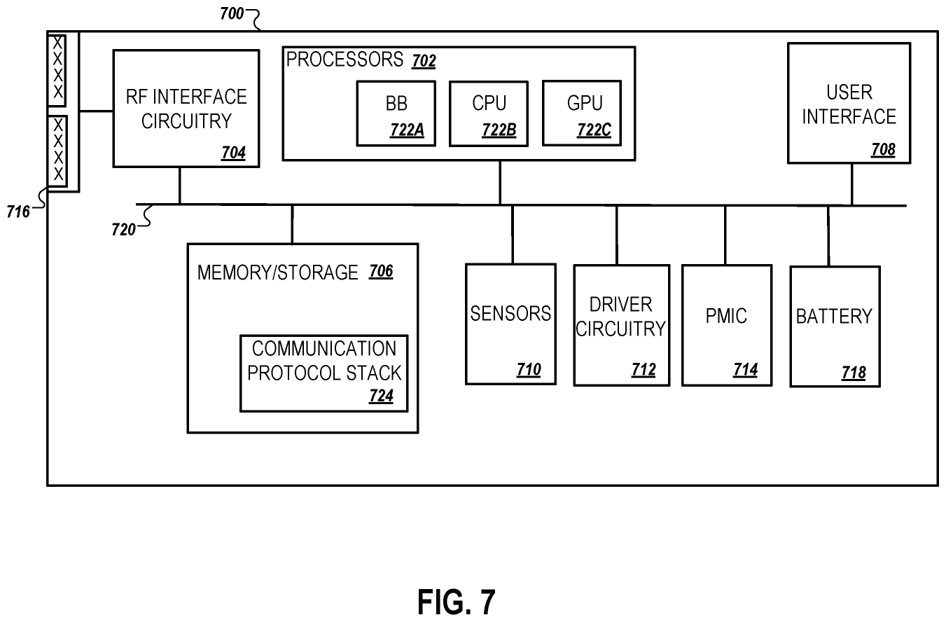

FIG. 7 illustrates a UE 700, in accordance with some implementations. The UE 700 may be similar to and substantially interchangeable with UEs 105 of FIG. 1.

The UE 700 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 700 may include processors 702, RF interface circuitry 704, memory/storage 706, user interface 708, sensors 710, driver circuitry 712, power management integrated circuit (PMIC) 714, one or more antennas 716, and battery 718. The components of the UE 700 may be implemented as integrated circuits (ICs), portions thereof, discrete electronic devices, or other modules, logic, hardware, software, firmware, or a combination thereof. The block diagram of FIG. 7 is intended to show a high-level view of some of the components of the UE 700. However, some of the components shown may be omitted, additional components may be present, and different arrangement of the components shown may occur in other implementations.

The components of the UE 700 may be coupled with various other components over one or more interconnects 720, which may represent any type of interface, input/output, bus (local, system, or expansion), transmission line, trace, optical connection, etc. that allows various circuit components (on common or different chips or chipsets) to interact with one another.

The processors 702 may include processor circuitry such as, for example, baseband processor circuitry (BB) 722A, central processor unit circuitry (CPU) 722B, and graphics processor unit circuitry (GPU) 722C. The processors 702 may include any type of circuitry or processor circuitry that executes or otherwise operates computer-executable instructions, such as program code, software modules, or functional processes from memory/storage 706 to cause the UE 700 to perform operations as described herein.

In some implementations, the processors 702 are configured to generate a communication for transmission on a sidelink channel operating in an unlicensed bandwidth. Further, the processors 702 are configured to determine a configuration of a resource pool of the sidelink channel, where the configuration is based on one of a frame based equipment (FBE) or a load based equipment (LBE) mechanism. Yet further, the processors 702 are configured to determine, from the resource pool, one or more resources on which to transmit the communication. Also, the processors 702 are configured to prepare the communication for transmission on the sidelink channel using the one or more resources.

In some implementations, the baseband processor circuitry 722A may access a communication protocol stack 724 in the memory/storage 706 to communicate over a 3GPP compatible network. In general, the baseband processor circuitry 722A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 704. The baseband processor circuitry 722A may generate or process baseband signals or waveforms that carry information in 3GPP-compatible networks. In some implementations, the waveforms for NR may be based cyclic prefix OFDM “CP-OFDM” in the uplink or downlink, and discrete Fourier transform spread OFDM “DFT-S-OFDM” in the uplink.

The memory/storage 706 may include one or more non-transitory, computer-readable media that includes instructions (for example, communication protocol stack 724) that may be executed by one or more of the processors 702 to cause the UE 700 to perform various operations described herein. The memory/storage 706 include any type of volatile or non-volatile memory that may be distributed throughout the UE 700. In some implementations, some of the memory/storage 706 may be located on the processors 702 themselves (for example, L1 and L2 cache), while other memory/storage 706 is external to the processors 702 but accessible thereto via a memory interface. The memory/storage 706 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 704 may include transceiver circuitry and radio frequency front module (RFEM) that allows the UE 700 to communicate with other devices over a radio access network. The RF interface circuitry 704 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via one or more antennas 716 and proceed to filter and amplify (with a low-noise amplifier) the signal. The signal may be provided to a receiver of the transceiver that downconverts the RF signal into a baseband signal that is provided to the baseband processor of the processors 702.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 716.

In various implementations, the RF interface circuitry 704 may be configured to transmit/receive signals in a manner compatible with NR access technologies.

The antenna 716 may include antenna elements to convert electrical signals into radio waves to travel through the air and to convert received radio waves into electrical signals. The antenna elements may be arranged into one or more antenna panels. The antenna 716 may have antenna panels that are omnidirectional, directional, or a combination thereof to enable beamforming and multiple input, multiple output communications. The antenna 716 may include microstrip antennas, printed antennas fabricated on the surface of one or more printed circuit boards, patch antennas, phased array antennas, etc. The antenna 716 may have one or more panels designed for specific frequency bands including bands in FRI or FR2.

The user interface 708 includes various input/output (I/O) devices designed to enable user interaction with the UE 700. The user interface 708 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 700.

The sensors 710 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 712 may include software and hardware elements that operate to control particular devices that are embedded in the UE 700, attached to the UE 700, or otherwise communicatively coupled with the UE 700. The driver circuitry 712 may include individual drivers allowing other components to interact with or control various input/output (I/O) devices that may be present within, or connected to, the UE 700. For example, driver circuitry 712 may include a display driver to control and allow access to a display device, a touchscreen driver to control and allow access to a touchscreen interface, sensor drivers to obtain sensor readings of sensors 728 and control and allow access to sensors 728, drivers to obtain actuator positions of electro-mechanic components or control and allow access to the electro-mechanic components, a camera driver to control and allow access to an embedded image capture device, audio drivers to control and allow access to one or more audio devices.

The PMIC 714 may manage power provided to various components of the UE 700. In particular, with respect to the processors 702, the PMIC 714 may control power-source selection, voltage scaling, battery charging, or DC-to-DC conversion.

In some implementations, the PMIC 714 may control, or otherwise be part of, various power saving mechanisms of the UE 700 including DRX as discussed herein. A battery 718 may power the UE 700, although in some examples the UE 700 may be mounted deployed in a fixed location, and may have a power supply coupled to an electrical grid. The battery 718 may be a lithium ion battery, a metal-air battery, such as a zinc-air battery, an aluminum-air battery, a lithium-air battery, and the like. In some implementations, such as in vehicle-based applications, the battery 718 may be a typical lead-acid automotive battery.

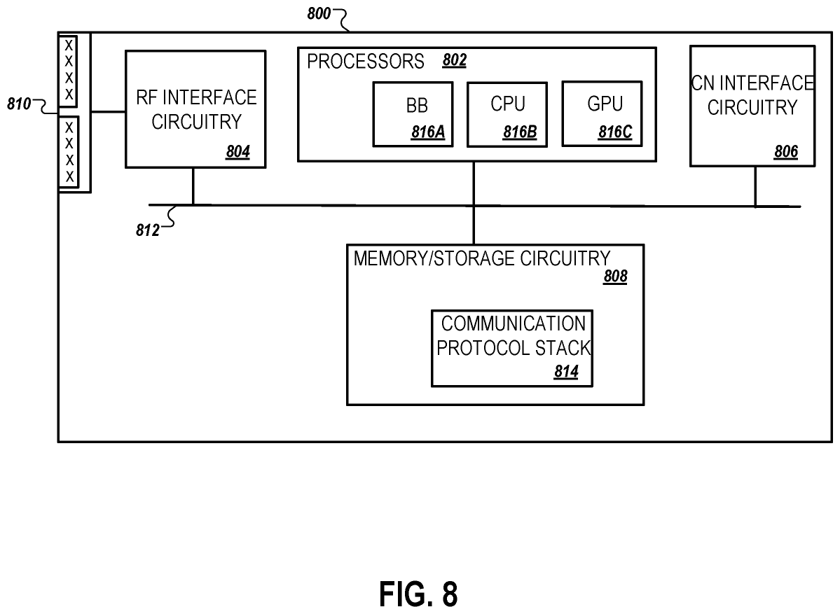

FIG. 8 illustrates an access node 800 (e.g., a base station or gNB), in accordance with some implementations. The access node 800 may be similar to and substantially interchangeable with base stations 110. The access node 800 may include processors 802, RF interface circuitry 804, core network (CN) interface circuitry 806, memory/storage circuitry 808, and one or more antennas 810.

The components of the access node 800 may be coupled with various other components over one or more interconnects 812. The processors 802, RF interface circuitry 804, memory/storage circuitry 808 (including communication protocol stack 814), antennas 810, and interconnects 812 may be similar to like-named elements shown and described with respect to FIG. 7. For example, the processors 802 may include processor circuitry such as, for example, baseband processor circuitry (BB) 816A, central processor unit circuitry (CPU) 816B, and graphics processor unit circuitry (GPU) 816C.

The CN interface circuitry 806 may provide connectivity to a core network, for example, a 5th Generation Core network (5GC) using a 5GC-compatible network interface protocol such as carrier Ethernet protocols, or some other suitable protocol. Network connectivity may be provided to/from the access node 800 via a fiber optic or wireless backhaul. The CN interface circuitry 806 may include one or more dedicated processors or FPGAs to communicate using one or more of the aforementioned protocols. In some implementations, the CN interface circuitry 806 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 800 that operates in an NR or 5G system (for example, a gNB), and the term “E-UTRAN node” or the like may refer to an access node 800 that operates in an LTE or 4G system (e.g., an eNB). According to various implementations, the access node 800 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 800 may be implemented as one or more software entities running on server computers as part of a virtual network, which may be referred to as a CRAN and/or a virtual baseband unit pool (vBBUP). In these implementations, the CRAN or vBBUP may implement a RAN function split, such as a PDCP split wherein RRC and PDCP layers are operated by the CRAN/vBBUP and other L2 protocol entities are operated by the access node 800; a MAC/PHY split wherein RRC, PDCP, RLC, and MAC layers are operated by the CRAN/vBBUP and the PHY layer is operated by the access node 800; or a “lower PHY” split wherein RRC, PDCP, RLC, MAC layers and upper portions of the PHY layer are operated by the CRAN/vBBUP and lower portions of the PHY layer are operated by the access node 800.

In V2X scenarios, the access node 800 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following section, further exemplary embodiments are provided.

Example 1 includes a method that involves generating a communication for transmission on a sidelink channel operating in an unlicensed bandwidth; determining a configuration of a resource pool of the sidelink channel, where the configuration is based on one of a frame based equipment (FBE) or a load based equipment (LBE) mechanism; determining, from the resource pool, one or more resources on which to transmit the communication; and transmitting the communication on the sidelink channel using the one or more resources.

Example 2 includes a method of Example 1, where determining the configuration of a resource pool of the sidelink channel involves determining at least one of a frequency domain configuration or a time domain configuration.

Example 3 includes a method of any of Examples 1-2, where the configuration of the resource pool is based on the FBE mechanism, and where determining the frequency domain configuration includes determining a number of frequency interlaces assigned to sidelink communications for the UE; determining, based on a subcarrier spacing of the sidelink channel, a number of physical resource blocks per interlace; and determining a physical resource block spacing in the sidelink channel.

Example 4 includes a method of any of Examples 1-3, where the configuration of the resource pool is based on the FBE mechanism, and where determining the time domain configuration involves determining, based on at least one of a configured granularity of time domain resources or a subcarrier spacing of the sidelink channel, a number of slots in the time domain; and determining, based on a bitmap, one or more slots assigned to sidelink communications for the UE.

Example 5 includes a method of any of Examples 1-4, where the configuration of the resource pool is based on the FBE mechanism, and the method further involves determining a physical layer structure for the one or more resources.

Example 6 includes a method of any of Example 1-5, where the communication is a Physical Sidelink Control Channel (PSCCH) communication, and where transmitting the communication on the sidelink channel using the one or more resources involves: determining an interlace design for the PSCCH communication in the physical layer structure; and transmitting the PSCCH communication based on the interlace design.

Example 7 includes a method of Example 5, where a first symbol of the physical layer structure is dedicated to automatic gain control (AGC).

Example 8 includes a method of Example 5, where determining a physical layer structure for the one or more resources involves calculating a minimum gap in the physical layer structure.

Example 9 includes a method of any of Examples 1-2, where the configuration of the resource pool is based on the LBE mechanism, and where determining the frequency domain configuration involves determining whether a full bandwidth or a partial bandwidth of the sidelink channel is dedicated to the UE for sidelink communications.

Example 10 includes a method of Example 9, where determining whether a full bandwidth or a partial bandwidth of the sidelink channel is dedicated to the UE for sidelink communications involves determining that the partial bandwidth is dedicated to the UE for sidelink communications; and in response, determining to start transmission only at slot boundary after one additional one shot listen-before-talk (LBT).

Example 11 includes a method of Example 9, where determining whether a full bandwidth or a partial bandwidth of the sidelink channel is dedicated to the UE for sidelink communications involves determining that the full bandwidth is dedicated to the UE for sidelink communications; and in response, determining to start transmission before a slot boundary.

Example 12 includes a method of any of Examples 1-2, where the configuration of the resource pool is based on the LBE mechanism, and where determining the time domain configuration involves determining whether a full bandwidth or a partial bandwidth of the sidelink channel is dedicated to the UE for sidelink communications.

Example 13 includes a method of Example 12, where determining whether a full bandwidth or a partial bandwidth of the sidelink channel is dedicated to the UE for sidelink communications involves determining that the partial bandwidth is dedicated to the UE for sidelink communications; and in response, determining that a bitmap is used to configure starting points of the one or more resources on which to transmit the communication.

Example 14 includes a method of Example 12, where determining whether a full bandwidth or a partial bandwidth of the sidelink channel is dedicated to the UE for sidelink communications involves determining that the full bandwidth is dedicated to the UE for sidelink communications; and in response, determining that transmitting the communication on the sidelink channel can start at any time.

Example 15 includes a method of Example 1, where the configuration of the resource pool is based on the FBE mechanism, and the method further involves determining a physical layer structure for the one or more resources.

Example 16 includes a method of Example 15, where the communication is a Physical Sidelink Control Channel (PSCCH) communication, and where transmitting the communication on the sidelink channel using the one or more resources involves determining an interlace design for the PSCCH communication in the physical layer structure; and transmitting the PSCCH communication based on the interlace design.

Example 17 may include one or more non-transitory computer-readable media including instructions to cause an electronic device, upon execution of the instructions by one or more processors of the electronic device, to perform one or more elements of a method described in or related to any of examples 1-16, or any other method or process described herein.

Example 18 may include an apparatus including logic, modules, or circuitry to perform one or more elements of a method described in or related to any of examples 1-16, or any other method or process described herein.

Example 19 may include a method, technique, or process as described in or related to any of examples 1-16, or portions or parts thereof.

Example 20 may include an apparatus including: one or more processors and one or more computer-readable media including instructions that, when executed by the one or more processors, cause the one or more processors to perform the method, techniques, or process as described in or related to any of examples 1-16, or portions thereof.

Example 21 may include a signal as described in or related to any of examples 1-16, or portions or parts thereof.

Example 22 may include a datagram, information element, packet, frame, segment, PDU, or message as described in or related to any of examples 1-16, or portions or parts thereof, or otherwise described in the present disclosure.

Example 23 may include a signal encoded with data as described in or related to any of examples 1-16, or portions or parts thereof, or otherwise described in the present disclosure.

Example 24 may include a signal encoded with a datagram, IE, packet, frame, segment, PDU, or message as described in or related to any of examples 1-16, or portions or parts thereof, or otherwise described in the present disclosure.

Example 25 may include an electromagnetic signal carrying computer-readable instructions, where execution of the computer-readable instructions by one or more processors is to cause the one or more processors to perform the method, techniques, or process as described in or related to any of examples 1-16, or portions thereof.

Example 26 may include a computer program including instructions, where execution of the program by a processing element is to cause the processing element to carry out the method, techniques, or process as described in or related to any of examples 1-16, or portions thereof. The operations or actions performed by the instructions executed by the processing element can include the methods of any one of examples 1-16.

Example 27 may include a signal in a wireless network as shown and described herein.

Example 28 may include a method of communicating in a wireless network as shown and described herein.

Example 29 may include a system for providing wireless communication as shown and described herein. The operations or actions performed by the system can include the methods of any one of examples 1-16.

Example 30 may include a device for providing wireless communication as shown and described herein. The operations or actions performed by the device can include the methods of any one of examples 1-16.

The previously-described examples 1-16 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

A system, e.g., a base station, an apparatus including one or more baseband processors, and so forth, can be configured to perform particular operations or actions by virtue of having software, firmware, hardware, or a combination of them installed on the system that in operation causes or cause the system to perform the actions. The operations or actions performed either by the system can include the methods of any one of examples 1-16.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. One or more processors configured to perform operations comprising:
generating a communication for transmission on a sidelink channel operating in an unlicensed bandwidth;
determining a configuration of a resource pool of the sidelink channel;
determining, from the resource pool, a plurality of resources arranged in at least one interlace for transmitting the communication; and
causing a user equipment (UE) to transmit the communication on the sidelink channel using the plurality of resources.

2. The one or more processors of claim 1, wherein determining the configuration of a resource pool of the sidelink channel comprises:
determining at least one of a frequency domain configuration or a time domain configuration.

3. The one or more processors of claim 2, wherein determining the frequency domain configuration comprises:
determining a number of frequency interlaces assigned to sidelink communications for the UE;
determining, based on a subcarrier spacing of the sidelink channel, a number of physical resource blocks per interlace; and
determining a physical resource block spacing in the sidelink channel.

4. The one or more processors claim 2, wherein determining the time domain configuration comprises:
determining, based on at least one of a configured granularity of time domain resources or a subcarrier spacing of the sidelink channel, a number of slots in the time domain; and
determining, based on a bitmap, one or more slots assigned to sidelink communications for the UE.

5. (canceled)

6. The one or more processors of claim 1, wherein the communication is a Physical Sidelink Control Channel (PSCCH) communication, and wherein transmitting the communication on the sidelink channel using the plurality of resources comprises:
determining an interlace design for the PSCCH communication in a physical layer structure; and
transmitting the PSCCH communication based on the interlace design.

7. The one or more processors of claim 6, wherein a first symbol of the physical layer structure is dedicated to automatic gain control (AGC).

8. The one or more processors of claim 6, the operations further comprising:
calculating a minimum gap in the physical layer structure.

9. The one or more processors of claim 2, wherein determining the frequency domain configuration comprises:
determining whether a full bandwidth or a partial bandwidth of the sidelink channel is dedicated to the UE for sidelink communications.

10. The one or more processors of claim 9, wherein determining whether a full bandwidth or a partial bandwidth of the sidelink channel is dedicated to the UE for sidelink communications comprises:
determining that the partial bandwidth is dedicated to the UE for sidelink communications; and
in response, determining to start transmission only at slot boundary after one additional one shot listen-before-talk (LBT).

11. The one or more processors of claim 9, wherein determining whether a full bandwidth or a partial bandwidth of the sidelink channel is dedicated to the UE for sidelink communications comprises:
determining that the full bandwidth is dedicated to the UE for sidelink communications; and
in response, determining to start transmission before a slot boundary.

12. The one or more processors of claim 2, wherein determining the time domain configuration comprises:
determining whether a full bandwidth or a partial bandwidth of the sidelink channel is dedicated to the UE for sidelink communications.

13. The one or more processors of claim 12, wherein determining whether a full bandwidth or a partial bandwidth of the sidelink channel is dedicated to the UE for sidelink communications comprises:
determining that the partial bandwidth is dedicated to the UE for sidelink communications; and
in response, determining that a bitmap is used to configure starting points of the plurality of resources on which to transmit the communication.

14. The one or more processors of claim 12, wherein determining whether a full bandwidth or a partial bandwidth of the sidelink channel is dedicated to the UE for sidelink communications comprises:
determining that the full bandwidth is dedicated to the UE for sidelink communications; and
in response, determining that transmitting the communication on the sidelink channel can start at any time.

15. (canceled)

16. The one or more processors of claim 1, wherein the communication is a sidelink channel communication, and wherein transmitting the communication on the sidelink channel using the plurality of resources comprises:
determining an interlace design for the sidelink channel communication in a physical layer structure for the plurality of resources; and
transmitting the sidelink channel communication based on the interlace design.

17. A method comprising:
generating a communication for transmission on a sidelink channel operating in an unlicensed bandwidth;
determining a configuration of a resource pool of the sidelink channel;
determining, from the resource pool, a plurality of resources arranged in at least one interlace for transmitting the communication; and
transmitting the communication on the sidelink channel using the plurality of resources.

18. The method of claim 17, wherein determining the configuration of a resource pool of the sidelink channel comprises:
determining at least one of a frequency domain configuration or a time domain configuration.

19. The method of claim 18, wherein determining the frequency domain configuration comprises:
determining a number of frequency interlaces assigned to sidelink communications;
determining, based on a subcarrier spacing of the sidelink channel, a number of physical resource blocks per interlace; and
determining a physical resource block spacing in the sidelink channel.

20. The method of claim 18, wherein determining the time domain configuration comprises:
determining, based on at least one of a configured granularity of time domain resources or a subcarrier spacing of the sidelink channel, a number of slots in the time domain; and
determining, based on a bitmap, one or more slots assigned to sidelink communications.

21. A user equipment (UE) comprising:
a radio frequency transceiver;
one or more processers; and
memory storing instructions that, when executed by the one or more processers, cause the UE to perform operations comprising:
generating a communication for transmission on a sidelink channel operating in an unlicensed bandwidth;
determining a configuration of a resource pool of the sidelink channel;
determining, from the resource pool, a plurality of resources arranged in at least one interlace for transmitting the communication; and
transmitting the communication on the sidelink channel using the plurality of resources.

22. The one or more processors of claim 1, wherein the at least one interlace is one interlace.
